(19) United States
(12) Patent Application Publication
(10) Pub. No.: US 2023/0359997 A1
(43) Pub. Date: Nov. 9, 2023

(54) WORKPLACE COLLABORATIVE APPLICATION INFORMATION SYNTHESIS

(71) Applicant: INTERNATIONAL BUSINESS MACHINES CORPORATION, ARMONK, NY (US)

(72) Inventors: Shikha Srivastava, Cary, NC (US); Vikram Rengarajan, Irving, TX (US)

(21) Appl. No.: 17/662,457

(22) Filed: May 9, 2022

(51) Int. Cl. G06Q 10/10; H04L 9/40

(52) U.S. Cl. CPC G06Q 10/103; H04L 63/0815

(57) ABSTRACT

An embodiment for synthesizing collaborative application information in the workplace is provided. The embodiment may include receiving login credentials from a user when the user opens a collaboration application. The embodiment may also include identifying organizational metadata associated with the user from a business ledger. The embodiment may further include identifying one or more communications initiated with the login credentials. The embodiment may also include automatically adding the user to one or more open discussions. The embodiment may further include in response to determining the user wants an enhanced display in the collaboration application, displaying the one or more open discussions in the collaboration application and one or more insights. The embodiment may also include providing one or more recommended personalized dialog snippets to the user.

### BACKGROUND

The present invention relates generally to the field of computing, and more particularly to a system for synthesizing collaborative application information in the workplace.

Collaboration applications, including video conferencing, instant messaging, and email applications have become an effective interaction and communication tool that enables both small and large-scale companies to reduce travel and operational costs. Such software is extremely helpful in bridging the distance between employees in these small and large-scale companies and allowing them to communicate with each other and with clients in real-time. It has been estimated that these employees spend approximately 80% of the workday engaged with various collaboration applications. Workplace modernization as well as the desire for remote workforce management are expected to continue the demand for collaboration applications in the coming decades.

### SUMMARY

According to one embodiment, a method, computer system, and computer program product for synthesizing collaborative application information in the workplace is provided. The embodiment may include receiving login credentials from a user when the user opens a collaboration application. The embodiment may also include identifying organizational metadata associated with the user from a business ledger based on the login credentials. The embodiment may further include identifying one or more communications initiated with the login credentials. The embodiment may also include automatically adding the user to one or more open discussions based on the one or more communications and the organizational metadata. The embodiment may further include in response to determining the user wants an enhanced display in the collaboration application, displaying the one or more open discussions in the collaboration application and one or more insights. The embodiment may also include providing one or more recommended personalized dialog snippets to the user based on the one or more open discussions.

### BRIEF DESCRIPTION OF THE SEVERAL VIEWS OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 illustrates an exemplary networked computer environment according to at least one embodiment.

FIG. 2 illustrates an operational flowchart for synthesizing collaborative application information in the workplace in a workplace collaborative application information synthesis process according to at least one embodiment.

FIG. 3 is a diagram depicting an operational example of artificial intelligence (AI) insights that are displayed to users during the process in FIG. 2 according to at least one embodiment.

FIG. 4 is a functional block diagram of internal and external components of computers and servers depicted in FIG. 1 according to at least one embodiment.

FIG. 5 depicts a cloud computing environment according to an embodiment of the present invention.

FIG. 6 depicts abstraction model layers according to an embodiment of the present invention.

### DETAILED DESCRIPTION

Detailed embodiments of the claimed structures and methods are disclosed herein; however, it can be understood that the disclosed embodiments are merely illustrative of the claimed structures and methods that may be embodied in various forms. This invention may, however, be embodied in many different forms and should not be construed as limited to the exemplary embodiments set forth herein. In the description, details of well-known features and techniques may be omitted to avoid unnecessarily obscuring the presented embodiments.

It is to be understood that the singular forms “a,” “an,” and “the” include plural referents unless the context clearly dictates otherwise. Thus, for example, reference to “a component surface” includes reference to one or more of such surfaces unless the context clearly dictates otherwise.

Embodiments of the present invention relate to the field of computing, and more particularly to a system for synthesizing collaborative application information in the workplace. The following described exemplary embodiments provide a system, method, and program product to, among other things, automatically add a user to one or more open discussions based on one or more communications initiated by the user and organizational metadata and, accordingly, display the one or more open discussions in a collaboration application along with one or more insights. Therefore, the present embodiment has the capacity to improve the technical field of collaboration applications by dynamically routing a conversation initiated by the user to a proper authority, thus enhancing the functionalities of the collaboration applications.

As previously described, collaboration applications, including video conferencing, instant messaging, and email applications have become an effective interaction and communication tool that enables both small and large-scale companies to reduce travel and operational costs. Such software is extremely helpful in bridging the distance between employees in these small and large-scale companies and allowing them to communicate with each other and with clients in real-time. It has been estimated that these employees spend approximately 80% of the workday engaged with various collaboration applications. Workplace modernization as well as the desire for remote workforce management are expected to continue the demand for collaboration applications in the coming decades. Currently, the information available from multiple collaboration applications, including one or more communications initiated by a user, is isolated and limited to the individual collaboration applications. For example, the user may have engaged in a communication in both an email application as well as an instant messaging application. The email application may not have knowledge of the communication in the instant messaging application, and vice versa. This problem is typically addressed by prompting the user to manually enter the context of the communication and/or certain information about the user. However, this approach requires the user to drill down through many layers to get to desired data or functionality, and there is no guarantee that the information provided by the user will be accurate.

It may therefore be imperative to have a system in place to reduce information silos and synthesize the information available from multiple collaboration applications. Thus, embodiments of the present invention may provide advantages including, but not limited to, dynamically routing a conversation initiated by the user to a proper authority, reducing information silos and synthesizing the information available from multiple collaboration applications, and automatically adding the user to one or more workplace communication channels. The present invention does not require that all advantages need to be incorporated into every embodiment of the invention.

According to at least one embodiment, when a user intends to start a conversation in a collaboration application, login credentials may be received from the user when the user opens the collaboration application in order to identify organizational metadata associated with the user from a business ledger based on the login credentials. Upon identifying the organizational metadata, one or more communications initiated with the login credentials may be identified so that the user may automatically be added to one or more open discussions based on the one or more communications and the organizational metadata. According to at least one embodiment, the one or more open discussions may be one or more threads. According to at least one other embodiment, the one or more open discussions may be a communication channel within the collaboration application. According to at least one further embodiment, the one or more open discussions may be a group forum. In response to determining the user wants an enhanced display in the collaboration application, the one or more open discussions may be displayed in the collaboration application along with one or more insights. Upon displaying the one or more open discussions, one or more recommended personalized dialog snippets may be provided to the user based on the one or more open discussions.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed concurrently or substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The following described exemplary embodiments provide a system, method, and program product to automatically add a user to one or more open discussions based on one or more communications initiated by the user and organizational metadata and, accordingly, display the one or more open discussions in a collaboration application along with one or more insights.

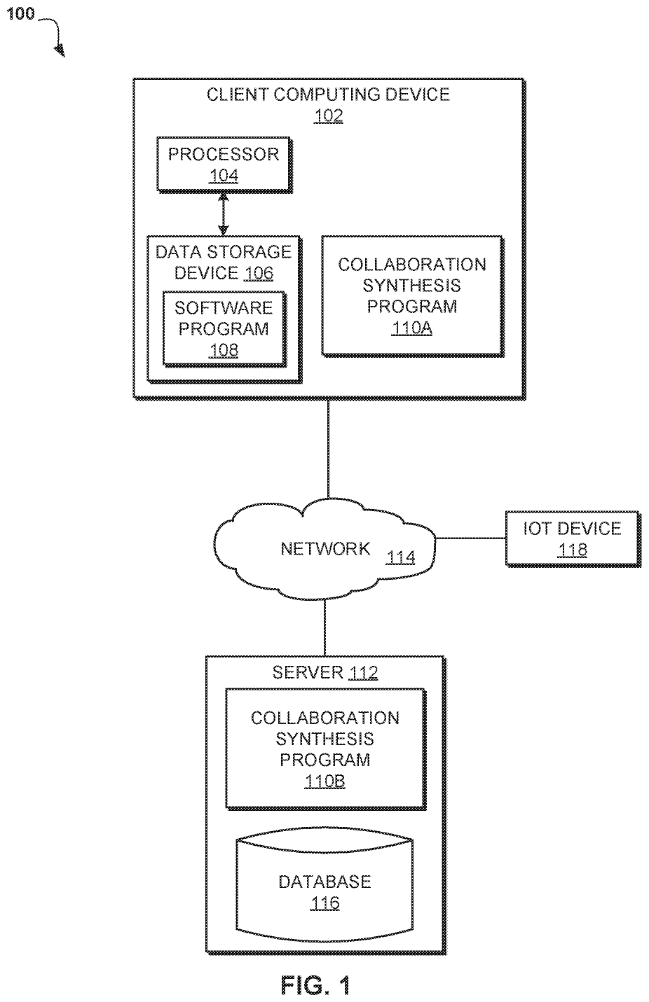

Referring to FIG. 1, an exemplary networked computer environment 100 is depicted, according to at least one embodiment. The networked computer environment 100 may include client computing device 102, a server 112, and Internet of Things (IoT) Device 118 interconnected via a communication network 114. According to at least one implementation, the networked computer environment 100 may include a plurality of client computing devices 102 and servers 112, of which only one of each is shown for illustrative brevity.

The communication network 114 may include various types of communication networks, such as a wide area network (WAN), local area network (LAN), a telecommunication network, a wireless network, a public switched network and/or a satellite network. The communication network 114 may include connections, such as wire, wireless communication links, or fiber optic cables. It may be appreciated that FIG. 1 provides only an illustration of one implementation and does not imply any limitations with regard to the environments in which different embodiments may be implemented. Many modifications to the depicted environments may be made based on design and implementation requirements.

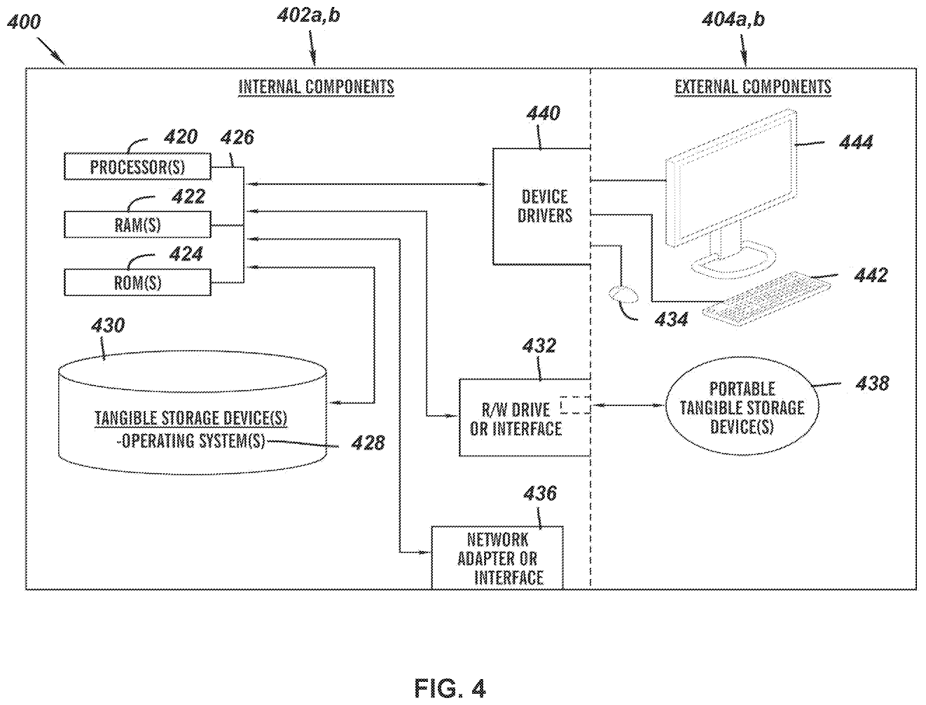

Client computing device 102 may include a processor 104 and a data storage device 106 that is enabled to host and run a software program 108 and a collaboration synthesis program 110A and communicate with the server 112 and IoT Device 118 via the communication network 114, in accordance with one embodiment of the invention. Client computing device 102 may be, for example, a mobile device, a telephone, a personal digital assistant, a netbook, a laptop computer, a tablet computer, a desktop computer, or any type of computing device capable of running a program and accessing a network. As will be discussed with reference to FIG. 4, the client computing device 102 may include internal components 402a and external components 404a, respectively.

The server computer 112 may be a laptop computer, netbook computer, personal computer (PC), a desktop computer, or any programmable electronic device or any network of programmable electronic devices capable of hosting and running a collaboration synthesis program 110B and a database 116 and communicating with the client computing device 102 and IoT Device 118 via the communication network 114, in accordance with embodiments of the invention. As will be discussed with reference to FIG. 4, the server computer 112 may include internal components 402b and external components 404b, respectively. The server 112 may also operate in a cloud computing service model, such as Software as a Service (SaaS), Platform as a Service (PaaS), or Infrastructure as a Service (IaaS). The server 112 may also be located in a cloud computing deployment model, such as a private cloud, community cloud, public cloud, or hybrid cloud.

IoT Device 118 may be a microphone embedded in or external to the client computing device 102, a wireless headset, and/or any other IoT Device 118 known in the art for capturing audio output that is capable of connecting to the communication network 114, and transmitting and receiving data with the client computing device 102 and the server 112.

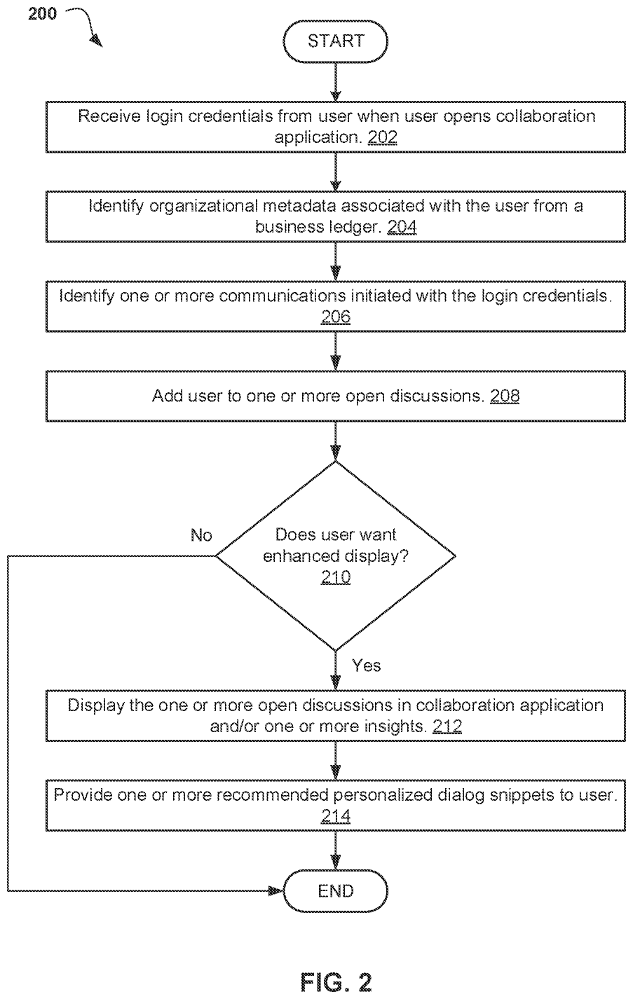

According to the present embodiment, the collaboration synthesis program 110A, 110B may be a program capable of receiving login credentials from a user when the user opens a collaboration application, identifying one or more communications initiated with the login credentials, displaying open discussions and insights in a single collaboration application, dynamically routing a conversation initiated by the user to a proper authority, reducing information silos and synthesizing the information available from multiple collaboration applications, and automatically adding the user to one or more workplace communication channels. The collaboration synthesis method is explained in further detail below with respect to FIG. 2.

Referring now to FIG. 2, an operational flowchart for synthesizing collaborative application information in the workplace in a workplace collaborative application information synthesis process 200 is depicted according to at least one embodiment. At 202, the collaboration synthesis program 110A, 110B receives the login credentials from the user when the user opens the collaboration application. The collaboration application may be any application where two or more users are able to communicate with each other, including but not limited to an email application, a video conferencing application, and/or an instant messaging application such as Slack® (Slack and all Slack-based trademarks and logos are trademarks or registered trademarks of Slack Technologies, Inc. and/or its affiliates). Upon opening the collaboration application, either through a web browser, or a desktop or mobile client, the user may be prompted to enter their login credentials. The received login credentials may be federated single sign-on (SSO) credentials of the user. These SSO credentials may have access to a plurality of collaboration applications within a business network. For example, one username and one password of the user may grant the user access to the email application, the video conferencing application, and the instant messaging application.

Then, at 204, the collaboration synthesis program 110A, 110B identifies the organizational metadata associated with the user from the business ledger. The organizational metadata is identified based on the login credentials (i.e., the SSO credentials) of the user. Once the user is verified based on the login credentials, the collaboration application may gain access to a business ledger. The business ledger may include, but is not limited to, an organizational glossary such as a list of departments within the organization, a list of employees (i.e., users) within the organization, and/or profiles of the users. Since the login credentials are unique to each user (i.e., each user has their own personal username and password), the collaboration application may be routed to the appropriate business profile. For example, when “User A” enters their login credentials into the collaboration application, the collaboration application may gain access to the business profile of “User A.”

The organizational metadata may be obtained by the collaboration synthesis program 110A, 110B from this business profile. Examples of the organizational metadata may include, but are not limited to, a name of the user, an ID of the user, an employer of the user, an assigned division of the user (e.g., sales and distribution), an assigned portfolio of the user (e.g., cloud, hybrid cloud), an assigned territory of the user (e.g., North America Midwest), a customer account of the user (e.g., Walmart® (Walmart and all Walmart-based trademarks and logos are trademarks or registered trademarks of Walmart, Inc. and/or its affiliates)), a status level of the user (e.g., junior, senior), skills of the user (e.g., software development, programming, management), and/or registered devices of the user. The registered devices of the user may provide an optional security feature described in further detail below with respect to step 208.

Next, at 206, the collaboration synthesis program 110A, 110B identifies the one or more communications initiated with the login credentials. The user may currently be engaged or may have previously been engaged in multiple communications in a variety of collaboration applications.

For example, the user may have several threaded email messages in their inbox (e.g., a back-and-forth conversation between the sender and the recipient) and the user may be involved in several conversations in different channels within the instant messaging application. The instant messaging application may have several “workspaces” in which the user is enrolled. Each of these “workspaces” may have multiple communication channels to which the user is subscribed. Continuing the example, the user may be involved in a dialog in three different channels in “Workspace 1,” two different channels in “Workspace 2,” and four different channels in “Workspace 3.” These dialogs may be related to one or more topics. It may be appreciated that in embodiments of the present invention, “initiated” does not necessarily mean that the first message in any communication is initiated with the login credentials. Rather, “initiated” means the first message entered by the user was entered when the user was logged-in to the collaboration application using the login credentials. For example, the user, who may be an employee in an organization, may be responding to a message started by a customer of that organization. In this example, the message from the user may be the second message in the conversation.

Thus, in embodiments of the present invention, the one or more communications described above may be one or more communications in which the user is involved while the user is logged-in with the login credentials, as opposed to those communications in which the user is not logged-in with the SSO credentials.

Then, at 208, the collaboration synthesis program 110A, 110B automatically adds the user to the one or more open discussions. The user is added to the one or more open discussions based on the one or more communications and the organizational metadata. The one or more open discussions may be conversations between employees in a business network in which the user is not currently involved, but would otherwise be open for the user to join if the user meets the access level for the discussion. For example, where the user is a junior level employee, the user may not have access to one or more discussions only open to company executives. Continuing the example, the user may, on the other hand, have access to a technical support community discussion regarding a particular issue. As an optional security feature, the user may automatically be added to the one or more open discussions when the SSO credentials of the user are entered into a device recognized by the business network. Such devices may include, but are not limited to, a mobile device, a laptop computer, a desktop computer, and/or a tablet computer. These devices may have a unique international mobile equipment identity (IMEI) number and/or serial number, which may also be stored as part of the metadata. Thus, when the SSO credentials are entered into a device having a different IMEI number or serial number than the approved devices in the metadata, the user may not be automatically added to the one or more open discussions.

According to at least one embodiment, the one or more open discussions may be one or more threads. The user may be automatically added to the one or more threads in the collaboration application based on the one or more communications and the organizational metadata associated with the user. Specifically, when the collaboration synthesis program 110A, 110B automatically adds the user to the one or more threads, the relevant organizational metadata may include an assigned portfolio, territory, and customer account of the user. For example, where the collaboration application opened by the user is the instant messaging application, and where the assigned portfolio of the user is cloud and hybrid cloud and the user communicated in other collaboration applications about cloud-based product offerings, the user may be added to one or more threads about the cloud-based product. Continuing the example, where the assigned territory of the user is in the Midwest region of North America, the user may be added to one or more threads specific to the Midwest region. Continuing the example, where the assigned customer account of the user is “Customer A,” the user may be added to one or more threads specific to “Customer A.”

According to at least one other embodiment, the one or more open discussions may be a communication channel within the collaboration application. The user may be automatically added to the one or more communication channels in the collaboration application based on the one or more communications and the organizational metadata associated with the user. For example, where the collaboration application opened by the user is the instant messaging application, and where the assigned portfolio of the user is cloud and hybrid cloud and the user communicated in other collaboration applications about cloud-based product offerings, the user may be added to one or more channels about the cloud-based product. Continuing the example, one of the channels may be a “Cloud Platform” channel.

According to at least one further embodiment, the one or more open discussions may be a group forum. The user may be automatically added to a group within the collaboration application based on the one or more communications and the organizational metadata associated with the user. For example, where the collaboration application opened by the user is a video conferencing application, and where the assigned portfolio of the user is cloud and hybrid cloud and the user communicated in other collaboration applications about cloud-based product offerings, the user may automatically be added as an invitee to one or more virtual meetings related to cloud-based products. In another example, where the collaboration application opened by the user is an email application, and where the assigned portfolio of the user is cloud and hybrid cloud and the user communicated in other collaboration applications about cloud-based product offerings, the user may automatically be added to a group email where there is a pre-existing conversation between other members of the cloud and/or hybrid cloud team. It may be appreciated that the examples described above are not intended to be limiting, and that in embodiments of the present invention the user may be automatically added to the one or more open discussions in a variety of different ways.

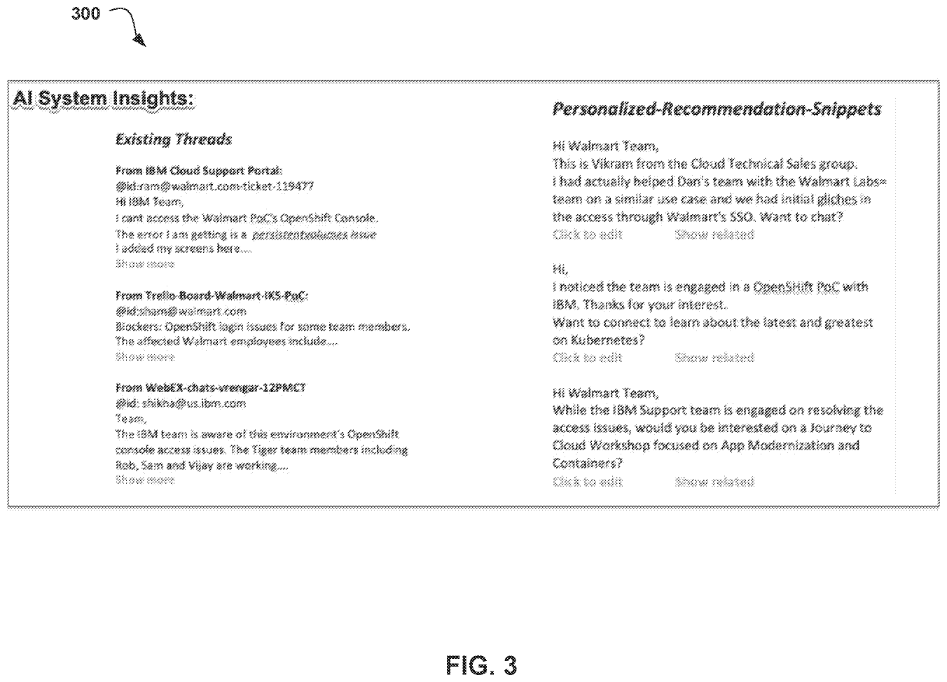

Next, at 210, the collaboration synthesis program 110A, 110B determines whether the user wants the enhanced display in the collaboration application. Upon automatically adding the user to the one or more open discussions as described above with respect to step 208, the collaboration synthesis program 110A, 110B may issue a prompt to the user asking the user whether they would like the enhanced display in the collaboration application. For example, the prompt may be in the form of a pop-up window with a “Yes” and “No” option. An example of the enhanced display is illustrated in FIG. 3.

In response to determining the user wants the enhanced display (step 210, “Yes” branch), the workplace collaborative application information synthesis process 200 proceeds to step 212 to display the one or more open discussions in the collaboration application and one or more insights. In response to determining the user does not want the enhanced display (step 210, “No” branch), the workplace collaborative application information synthesis process 200 ends.

Then, at 212, the collaboration synthesis program 110A, 110B displays the one or more open discussions in the collaboration application and the one or more insights. As described above with respect to step 210, when the user does not want the enhanced display, the content of the collaboration application may be displayed to the user in a traditional view. For example, the user may only see the channels and/or threads to which they manually subscribed. Contrarily, when the user does want the enhanced display, the traditional view of the collaboration application may be modified to include the one or more open discussions in the collaboration application and the one or more insights.

The one or more open discussions displayed to the user in the enhanced display may include the one or more open discussions described above with respect to step 208. Thus, in embodiments of the present invention, the user may be presented with a visual in one collaboration application of the open discussions the user has been automatically added to from a variety of other collaboration applications. For example, the user may log into an email application and be automatically added to a thread in the email application. Later, the user may log into an instant messaging application and be automatically added to a different thread. In this example, both threads may be displayed to the user in the instant messaging application. In this manner, information silos may be avoided and information from a variety of collaboration applications may be synthesized. Depending on the number of open discussions, a snippet of the one or more open discussions may be displayed to the user in the enhanced display, described in further detail below with respect to the description of FIG. 3.

The one or more insights may be displayed based on the organizational metadata associated with each user. For example, when the user is a subject matter expert (SME) who resolves technical issues for customers, the one or more insights may include, but are not limited to, customer information, customer requests, open support tickets, and/or type of products sold to the customer. In another example, when the user is the customer of an organization and the customer has SSO credentials granting them access to the various collaboration applications associated with the organization, then when the customer requires technical support for a specific issue the one or more insights may include, but are not limited to, a hierarchical chart of points of contact for the specific issue, a number of conversations each SME has had on that issue, clients the SME usually assists, as well as contact information for the SME. According to at least one embodiment, some of these insights may be displayed to the user in a scatter plot, such as information relating to the open support tickets. Thus, the user is not necessarily an employee of the organization, but may be another user outside the organization who is granted access to the various collaboration applications of the organization trough their SSO credentials.

Next, at 214, the collaboration synthesis program 110A, 110B provides the one or more recommended personalized dialog snippets to the user. The one or more recommended personalized dialog snippets are recommended to the user based on the one or more open discussions. An example of the personalized dialog snippets is illustrated in FIG. 3. When the user clicks or taps on one of the open discussions displayed to the user in the enhanced display, the user may be provided with recommended suggestions to continue the dialog. For example, when the user clicks on a cloud-based product thread, text may be automatically populated into the chat window which may be sent by the user, edited by the user, or deleted by the user (e.g., where the user wants to manually enter text). The user may manually enter the text through a keyboard and/or via the IoT Device 118, such as the wireless headset. The one or more recommended personalized dialog snippets may include information from previous communications initiated with the login credentials of the user where the previous communications related to the same or a similar topic of discussion.

Referring now to FIG. 3, a diagram 300 depicting an operational example of artificial intelligence (AI) insights that are displayed to users during the process in FIG. 2 is shown according to at least one embodiment. In the diagram 300, snippets of multiple threads may be displayed to the user in the enhanced display. The snippets may include a name of the thread, an ID of the users involved in the thread, and/or the first message at the beginning of the thread. The user may have the option to display the entire thread by tapping or clicking on a “show more” option displayed beneath each thread. In addition, according to at least one embodiment, a recommended personalized dialog snippet may be displayed to the user adjacent to each thread snippet. In this embodiment, the user may have the option to edit the recommended personalized dialog snippet or show related recommended personalized dialog snippets by tapping or clicking on a “click to edit” or “show related” option, respectively, displayed beneath each recommended personalized dialog snippet.

It may be appreciated that FIGS. 2 and 3 provide only an illustration of one implementation and do not imply any limitations with regard to how different embodiments may be implemented. Many modifications to the depicted environments may be made based on design and implementation requirements.

FIG. 4 is a block diagram 400 of internal and external components of the client computing device 102 and the server 112 depicted in FIG. 1 in accordance with an embodiment of the present invention. It should be appreciated that FIG. 4 provides only an illustration of one implementation and does not imply any limitations with regard to the environments in which different embodiments may be implemented. Many modifications to the depicted environments may be made based on design and implementation requirements.

The data processing system 402, 404 is representative of any electronic device capable of executing machine-readable program instructions. The data processing system 402, 404 may be representative of a smart phone, a computer system, PDA, or other electronic devices. Examples of computing systems, environments, and/or configurations that may represented by the data processing system 402, 404 include, but are not limited to, personal computer systems, server computer systems, thin clients, thick clients, hand-held or laptop devices, multiprocessor systems, microprocessor-based systems, network PCs, minicomputer systems, and distributed cloud computing environments that include any of the above systems or devices.

The client computing device 102 and the server 112 may include respective sets of internal components 402 a,b and external components 404 a,b illustrated in FIG. 4. Each of the sets of internal components 402 include one or more processors 420, one or more computer-readable RAMs 422, and one or more computer-readable ROMs 424 on one or more buses 426, and one or more operating systems 428 and one or more computer-readable tangible storage devices 430. The one or more operating systems 428, the software program 108 and the collaboration synthesis program 110A in the client computing device 102 and the collaboration synthesis program 110B in the server 112 are stored on one or more of the respective computer-readable tangible storage devices 430 for execution by one or more of the respective processors 420 via one or more of the respective RAMs 422 (which typically include cache memory). In the embodiment illustrated in FIG. 4, each of the computer-readable tangible storage devices 430 is a magnetic disk storage device of an internal hard drive. Alternatively, each of the computer-readable tangible storage devices 430 is a semiconductor storage device such as ROM 424, EPROM, flash memory or any other computer-readable tangible storage device that can store a computer program and digital information.

Each set of internal components 402 a,b also includes a R/W drive or interface 432 to read from and write to one or more portable computer-readable tangible storage devices 438 such as a CD-ROM, DVD, memory stick, magnetic tape, magnetic disk, optical disk or semiconductor storage device. A software program, such as the collaboration synthesis program 110A, 110B, can be stored on one or more of the respective portable computer-readable tangible storage devices 438, read via the respective R/W drive or interface 432, and loaded into the respective hard drive 430.

Each set of internal components 402 a,b also includes network adapters or interfaces 436 such as a TCP/IP adapter cards, wireless Wi-Fi interface cards, or 3G or 4G wireless interface cards or other wired or wireless communication links. The software program 108 and the collaboration synthesis program 110A in the client computing device 102 and the collaboration synthesis program 110B in the server 112 can be downloaded to the client computing device 102 and the server 112 from an external computer via a network (for example, the Internet, a local area network or other, wide area network) and respective network adapters or interfaces 436. From the network adapters or interfaces 436, the software program 108 and the collaboration synthesis program 110A in the client computing device 102 and the collaboration synthesis program 110B in the server 112 are loaded into the respective hard drive 430. The network may comprise copper wires, optical fibers, wireless transmission, routers, firewalls, switches, gateway computers and/or edge servers.

Each of the sets of external components 404 a,b can include a computer display monitor 444, a keyboard 442, and a computer mouse 434. External components 404 a,b can also include touch screens, virtual keyboards, touch pads, pointing devices, and other human interface devices. Each of the sets of internal components 402 a,b also includes device drivers 440 to interface to computer display monitor 444, keyboard 442, and computer mouse 434. The device drivers 440, R/W drive or interface 432, and network adapter or interface 436 comprise hardware and software (stored in storage device 430 and/or ROM 424).

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows: On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

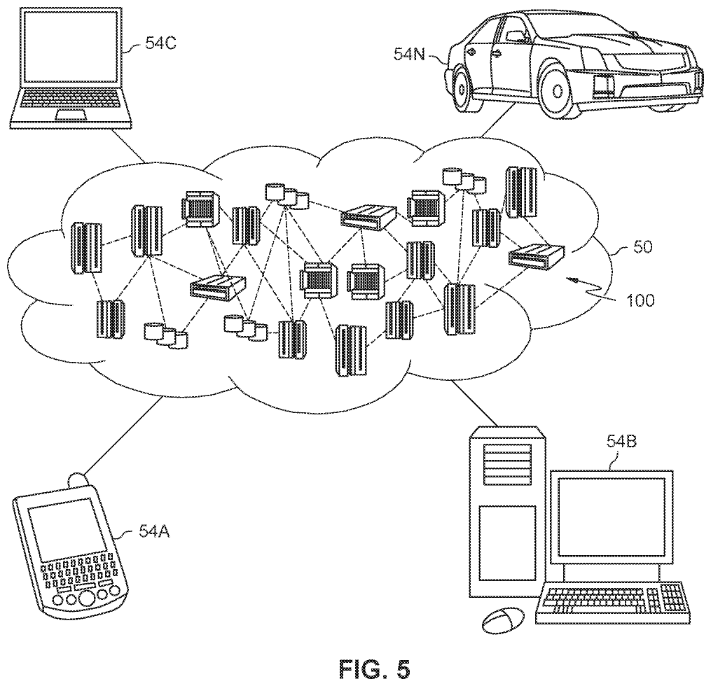

Referring now to FIG. 5, illustrative cloud computing environment 50 is depicted. As shown, cloud computing environment 50 comprises one or more cloud computing nodes 100 with which local computing devices used by cloud consumers, such as, for example, personal digital assistant (PDA) or cellular telephone 54A, desktop computer 54B, laptop computer 54C, and/or automobile computer system 54N may communicate. Nodes 100 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 5 are intended to be illustrative only and that computing nodes 100 and cloud computing environment 50 can communicate with any type of computerized device over any type of network and/or network addressable connection (e.g., using a web browser).

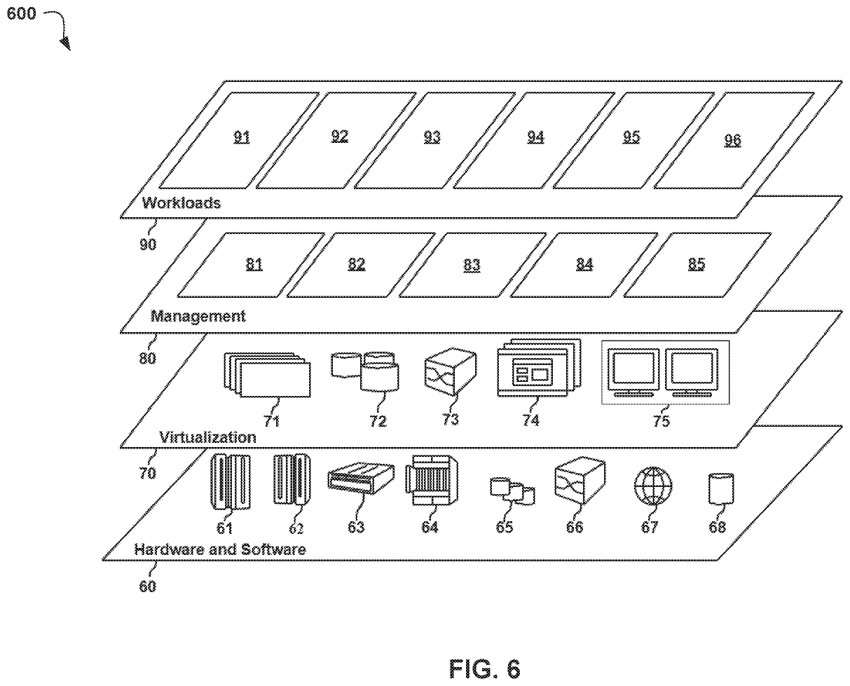

Referring now to FIG. 6, a set of functional abstraction layers 600 provided by cloud computing environment 50 is shown. It should be understood in advance that the components, layers, and functions shown in FIG. 6 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and synthesizing collaborative application information in the workplace 96. Synthesizing collaborative application information in the workplace 96 may relate to automatically adding a user to one or more open discussions based on one or more communications initiated by the user and organizational metadata in order to display the one or more open discussions in a collaboration application along with one or more insights.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-based method of synthesizing collaborative application information in the workplace, the method comprising:
receiving login credentials from a user when the user opens a collaboration application;
identifying organizational metadata associated with the user from a business ledger based on the login credentials;
identifying one or more communications initiated with the login credentials;
automatically adding the user to one or more open discussions based on the one or more communications and the organizational metadata;
determining whether the user wants an enhanced display in the collaboration application; and
in response to determining the user wants the enhanced display, displaying the one or more open discussions in the collaboration application and one or more insights.

2. The computer-based method of claim 1, further comprising:
providing one or more recommended personalized dialog snippets to the user based on the one or more open discussions.

3. The computer-based method of claim 1, wherein the received login credentials are federated single sign-on (SSO) credentials of the user having access to a plurality of collaboration applications within a business network.

4. The computer-based method of claim 3, wherein the user is automatically added to the one or more open discussions when the SSO credentials are entered into a device recognized by the business network.

5. The computer-based method of claim 1, wherein automatically adding the user to the one or more open discussions further comprises:
automatically adding the user to one or more groups and one or more threads in the collaboration application.

6. The computer-based method of claim 5, wherein the user is automatically added to the one or more threads based on an assigned portfolio, territory, and customer account of the user in the organizational metadata.

7. The computer-based method of claim 1, wherein the organizational metadata is selected from a group consisting of a name of the user, a status level of the user, registered devices of the user, skills of the user, and an assigned division of the user.

8. A computer system, the computer system comprising:
one or more processors, one or more computer-readable memories, one or more computer-readable tangible storage medium, and program instructions stored on at least one of the one or more computer-readable tangible storage medium for execution by at least one of the one or more processors via at least one of the one or more computer-readable memories, wherein the computer system is capable of performing a method comprising:
receiving login credentials from a user when the user opens a collaboration application;
identifying organizational metadata associated with the user from a business ledger based on the login credentials;
identifying one or more communications initiated with the login credentials;
automatically adding the user to one or more open discussions based on the one or more communications and the organizational metadata;
determining whether the user wants an enhanced display in the collaboration application; and
in response to determining the user wants the enhanced display, displaying the one or more open discussions in the collaboration application and one or more insights.

9. The computer system of claim 8, further comprising:
providing one or more recommended personalized dialog snippets to the user based on the one or more open discussions.

10. The computer system of claim 8, wherein the received login credentials are federated single sign-on (SSO) credentials of the user having access to a plurality of collaboration applications within a business network.

11. The computer system of claim 10, wherein the user is automatically added to the one or more open discussions when the SSO credentials are entered into a device recognized by the business network.

12. The computer system of claim 8, wherein automatically adding the user to the one or more open discussions further comprises:
automatically adding the user to one or more groups and one or more threads in the collaboration application.

13. The computer system of claim 12, wherein the user is automatically added to the one or more threads based on an assigned portfolio, territory, and customer account of the user in the organizational metadata.

14. The computer system of claim 8, wherein the organizational metadata is selected from a group consisting of a name of the user, a status level of the user, registered devices of the user, skills of the user, and an assigned division of the user.

15. A computer program product, the computer program product comprising:
one or more computer-readable tangible storage medium and program instructions stored on at least one of the one or more computer-readable tangible storage medium, the program instructions executable by a processor capable of performing a method, the method comprising:
receiving login credentials from a user when the user opens a collaboration application;
identifying organizational metadata associated with the user from a business ledger based on the login credentials;
identifying one or more communications initiated with the login credentials;
automatically adding the user to one or more open discussions based on the one or more communications and the organizational metadata;
determining whether the user wants an enhanced display in the collaboration application; and
in response to determining the user wants the enhanced display, displaying the one or more open discussions in the collaboration application and one or more insights.

16. The computer program product of claim 15, further comprising:
providing one or more recommended personalized dialog snippets to the user based on the one or more open discussions.

17. The computer program product of claim 15, wherein the received login credentials are federated single sign-on (SSO) credentials of the user having access to a plurality of collaboration applications within a business network.

18. The computer program product of claim 17, wherein the user is automatically added to the one or more open discussions when the SSO credentials are entered into a device recognized by the business network.

19. The computer program product of claim 15, wherein automatically adding the user to the one or more open discussions further comprises:
automatically adding the user to one or more groups and one or more threads in the collaboration application.

20. The computer program product of claim 19, wherein the user is automatically added to the one or more threads based on an assigned portfolio, territory, and customer account of the user in the organizational metadata.
